(19) United States
(12) Patent Application Publication
(10) Pub. No.: US 2009/0323833 A1
(43) Pub. Date: Dec. 31, 2009

(54) VERSATILE PLATFORM FOR BROADBAND WIRELESS SYSTEM DESIGN AND PROTOTYPING USING SOFTWARE DEFINED RADIO METHODOLOGY

(76) Inventor: Manoj Karayil Thekkoott Narayanan, Kerala (IN)

Correspondence Address: ALIX YALE & RISTAS LLP, 750 MAIN STREET, SUITE 1400, HARTFORD, CT, 06103, US

(21) Appl. No.: 12/309,892

(22) PCT Filed: Aug. 2, 2006
(86) PCT No.: PCT/IN06/00276

§ 371 Date: Feb. 2, 2009

(51) Int. Cl. H04L 27/00; H04B 1/38

(52) U.S. Cl. 375/259; 455/561

(57) ABSTRACT

The present invention relates to software defined radio (SDR) based wireless communication platform and, in particular, to a wireless communication system platform adapted for software defined radio methodology which would provide for a development platform for software defined radio implementation favouring programmability at the baseband and RF sections. Advantageously the system of the invention favours appropriate communication technique to match the environment and specifications of the user and supports a selective manner of up-converting the baseband signal which avoids the need for any sideband rejection filter at the RF output section thereby making the system also simple and cost-effective.

### FIELD OF THE INVENTION

The present invention relates to software defined radio (SDR) based wireless communication platform and, in particular, to a wireless communication system platform adapted for software defined radio methodology which would provide for a development platform for software defined radio implementation favouring programmability at the baseband and RF sections. Importantly, the invention is directed to a complete wireless communication system involving separate transmitting unit and receiving unit both adapted for programmability at the baseband and the RF sections which would be simple and user friendly to operate and use. Advantageously the system of the invention favours appropriate communication technique to match the environment and specifications of the user and supports a selective manner of up-converting the baseband signal which avoids the need for any sideband rejection filter at the RF output section thereby making the system also simple and cost-effective.

### BACKGROUND OF THE INVENTION

Software Defined Radio (SDR), is a design methodology suited for present day wireless communication scenario due to its inherent flexibility to accommodate various standards which are prevalent in the industry. Most of the products in this arena are integrated circuits which perform the predefined operations of an SDR based radio, but offer little flexibility to a researcher or a user to incorporate their innovations into the system being implemented.

The modern communication system implementation as a Software defined radio or otherwise is conducted in stages. The first stage of operation is performed at the base-band, part of the system where the data is processed by various sub systems to generate a low frequency version of the transmitted signal. The signal generated at the baseband is further processed at the Radio Frequency (RF) section, where the base-band output is up-converted, amplified and fed to the antenna. In a receiving system, the RF section downconverts the signal to the baseband region. The downconverted signal is then processed by the baseband section to recover the data. There exists no development platform for Software Defined Radio implementation which provides programmability at the baseband and the RF sections.

### OBJECTS OF THE INVENTION

It is thus the basic object of the present invention to provide a wireless communication system platform adapted for software defined radio methodology which would favour programmability at the baseband and RF sections.

Another object of the present invention is directed to a wireless communication system platform adapted for software defined radio methodology which would favour programmability at the baseband and RF sections for implementation of a broadband wireless communication system.

Another object of the present invention is to provide a wireless communication system platform adapted for software defined radio methodology with programmability at the baseband and RF sections involving two separate entities, the transmitting unit and the receiving unit and a master control software module to change the characteristics of the system by choosing appropriate communication technique to match the environment and the specification of the user.

A further object of the present invention is directed to a wireless communication system platform adapted for software defined radio methodology with programmability at the baseband and RF sections wherein a transmitting and a receiving units provide full flexibility in baseband and limited flexibility in the RF section.

Yet further object of the present invention is directed to provide for a novel way of up-converting the baseband signal to the Radio frequency signal. Which would advantageously eliminate the need of the sideband rejection filter at the RF output section.

Another object of the present invention is directed to a wireless communication system involving a software defined radio design platform which would be an end to end design platform adapted to provide a flexible and reconfigurable design platform for design and rapid prototyping of a broadband wireless communication system based on SDR methodology.

A further object of the present invention is directed to provide a wireless communication system adapted for software modules for a variety of selective user based and performance requirement based modulation techniques such as frequency shift keying, amplitude shift keying, binary phase shift keying, quaternary phase shift keying, 8-Phase shift keying, 8-quadrature amplitude modulation, 16-quadrature amplitude modulation and orthogonal frequency division multiplexing.

### SUMMARY OF THE INVENTION

Thus according to the basic aspect of the present invention there is provided a wireless communication system platform adapted for software defined radio methodology comprising of:
a) transmitting system comprising of a Field Programmable Gate Array (FPGA) with embedded software, an analog to digital converter, a digital to analog converter, a radio frequency up-conversion circuit and antenna, all operatively connected to constitute a wireless communication transmitter adapted for operational characteristics based on the software embedded FPGA;
b) receiving system comprising of a radio frequency down conversion circuit, an analog to digital conversion circuit, a Field Programmable Gate Array (FPGA) with embedded software, all operatively connected to constitute a wireless communication receiving system with selective operational characteristics from a multitude options to match the techniques adapted at the transmitter based on the software embedded FPGA;
   said transmitting system and said receiving system providing for said development platform adapted to selectively combine the Field Programmable Gate Array, the analog module comprising of an analog digital converter, digital to analog converter and the radio frequency circuit adapted to perform frequency up conversion or down conversion and amplify the signal strength for complete wireless communication system re-configurable and adaptive for a software defined radio.

In the above disclosed wireless communication system platform the said transmitting system is adapted to perform the essential operation of a broadband wireless transmitting system wherein various subsystem preferably selected from source encoding subsystem, data encryption sub-system, data interleaving sub system, error correction coding sub system, data formatting sub system, and a multiplicity of digital modulation subsystems and other operations provided in the form of software modules which are controlled by the master control software module thus offering multiple ways of transmitting digital data into the air interface by using the combination of the hardware comprising of said FPGA, analog module, the radio frequency up-conversion circuit and the antenna.

In accordance with an aspect in the wireless communication system platform the digital modulation sub-system comprises a multiplicity of modulation techniques preferably selected from frequency shift keying, amplitude shift keying, binary phase shift keying, quaternary phase shift keying, 8-phase shift keying, 8-quadrature amplitude modulation, 16-quadrature amplitude modulation and orthogonal frequency division multiplexing provided as embedded modules which are selected adaptively by either the user or a master controller software module to match the transmitting and receiving environments.

In the above wireless communication system the said receiving system is adapted to perform the essential receiver signal processing functions which comprises of downconverting the received signal to low frequency region for processing in an FPGA, converting the analog signal to a digital signal and the various sub-system of the receiver such as de-modulation subsystem, synchronization subsystem, decryption subsystem, error correction decoding subsystem, source decoding subsystem and an interface to the user provided in the form of embedded software modules thereby providing multiple ways of receiving the radio signal transmitted by the transmitter.

According to an aspect in the wireless communication system the demodulation subsystem comprises said FPGA having embedded software modules adapted for recovering data from the modulation technique such as frequency shift keying, amplitude shift keying, binary phase shift keying, quaternary phase shift keying, 8-phase shift keying, 8-quadrature amplitude modulation, 16-quadrature amplitude modulation, orthogonal frequency division multiplexing and also provide for the timing synchronization, carrier frequency and phase offset correction and other essential signal processing to enhance the received signal integrity and to reduce the number of the errors in the decoded data such as automatic gain control, noise limiting filter and the related technique as expected in a high performance wireless communication system.

The said separate hardware modules including Field Programmable Gate Array, analog module and the radio frequency circuit are seamlessly connected and the functionality and operational characteristics are controlled by a master control software module in said FPGA.

Importantly, the above system of the invention involves a master control software module adapted to control the operations of the FPGA based processor, the analog module and the radio frequency board from a single interface and enable the selection of the radio frequency channels, radio frequency transmitted power thereby providing a re-configurable radio frequency circuit which is controllable by the user.

In accordance with yet another aspect of the invention the wireless communication system is preferably adapted to upconvert the baseband signal to radio frequency signal by generating the sum of in-phase (I) and quadrature (Q) component within the baseband and the sum signal thus generated and its 90° phase shifted version adapted to be fed to the RF section whereby one of the side bands of the output is highly attenuated. The up-converted signal is fed to an appropriate antenna to match the transmitting frequency.

The subsystem in the transmitting unit are embedded as software module and adapted to be selectively operated either manually to predetermined mode of operation or adapted to selectively match the environment and requirements of communication link. For manual control a set of manual controls are provided externally. Alternatively, for said selective adaptability to match the environment and the requirement of communication link is completed by the master controlled software module and the said transmitter and receiver are adapted to determine the type of communication technique to set the channel of the transmission link.

Also, in the above system of the invention, the subsystems present as software modules in the receiver is adapted to match the operative performance in the transmitter. The received signal is synchronized by a digital costas loop.

In accordance with a preferred aspect the said digital costas loop is adapted to derive an error signal from the received signal based on the channel properties and other imperfect channels and this error signal is used to drive the numerically controlled oscillator to make it output frequency to be same as the incoming signal frequency.

The above disclosed wireless communication system of the invention apart from providing the much desired programmability at the baseband and the RF sections makes advantageous use of Software Defined Radio (SDR) which is a collection of hardware and software technologies that enable reconfigurable system architectures for wireless networks and user terminals. Thus the system involving the SDR provides an efficient and comparatively inexpensive solution to the problem of building multi-mode, multi-band, multi-functional wireless devices that can be enhanced using software upgrades. Thus such a programmable SDR based system is directed to serve as an enabling technology that would be applicable across a wide range of areas within the wireless industry.

The invention disclosed herein is thus directed to a development platform for broadband wireless systems which is based on Software Defined Radio methodology. As also apparent from the above, the system consists of two distinct parts, the transmitting unit and the receiving unit. The system is equipped with all the hardware and software required for implementation of a broadband wireless communication system.

Both the transmitting unit and the receiving unit comprises of many subsystems which enable the master control software module to change the characteristics of the system by choosing appropriate communication technique to match the environment and the specification of the user. These sub systems are embedded into the system as software modules. Both the transmitting and the receiving units provide full flexibility in baseband and limited flexibility in the RF section.

Importantly also the invention provides a novel way of up-converting the baseband signal to the Radio frequency signal. Unlike the conventional systems where the baseband signal is converted in to in-phase (I) and quadrature (Q) components and fed separately to the Radio frequency section separately, the invention generates the sum of I and Q within the baseband and the sum signal and its 90 degree phase shifted version are fed to the RF section. By this embodiment of the invention, one of the sideband of the output comes heavily attenuated and thus eliminates the need of the sideband rejection filter at the RF output section.

### BRIEF DESCRIPTION OF THE DRAWINGS

The details of the invention, its objects and advantages are explained hereunder in relation to the non-limiting accompanying exemplary illustrations as per the accompanying figures wherein:

FIG. 1. Schematic Diagram of Software Defined Radio Design Bench in accordance with the system of the present invention;

FIG. 2 Block diagram Transmitting unit subsystems in accordance with the system of the present invention;

FIG. 3. Block diagram of Receiving Unit sub systems in accordance with the system of the present invention;

FIG. 4. Block diagram of Modulation & Demodulation System in accordance with the system of the present invention;

FIG. 5. Block diagram of the QPSK Receiver signal processing in accordance with the system of the present invention;

FIG. 6. Block diagram of the novel RF up-conversion in accordance with the system of the present invention;

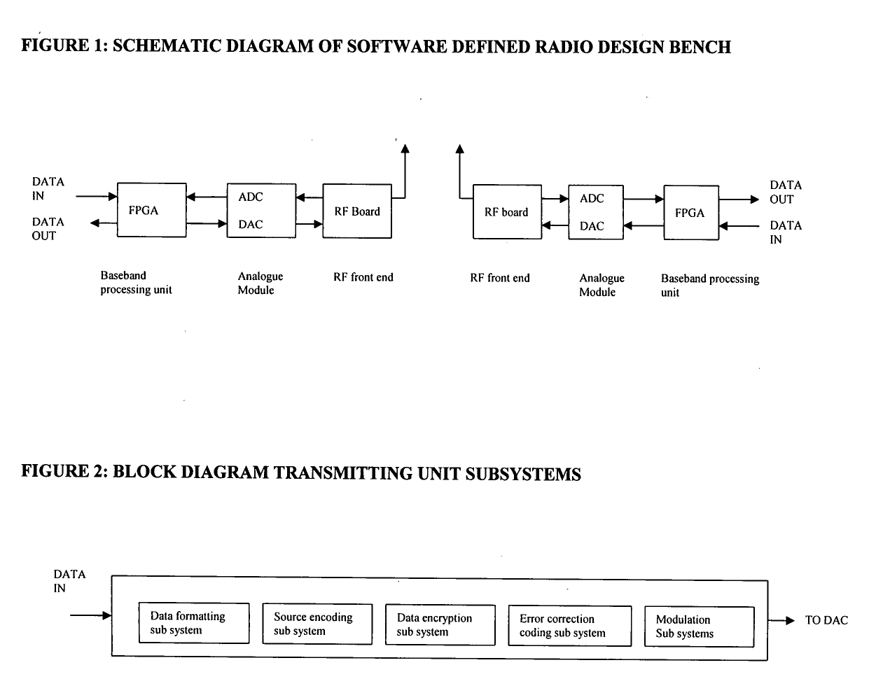

Reference is first invited to accompanying FIG. 1 which shows the block schematic of the system as two separate units. The FPGA based baseband processing board processes the data according to the software modules which are activated at any point of time. The sub systems which reside inside the FPGA are the essential communication functions such as source coding, error coding, encryption, interleaving, modulation and other related processing. The output from the FPGA block is passed through a digital to analog converter (DAC) to generate the analog signal. This analog signal is then fed to the RF section. At the RF section, the analog signal at the lower frequency region is up-converted to the radio frequency region. This up-converted signal is then fed to an appropriate antenna to match the transmission frequency.

At the receiver, the received signal is first downconverted to the lower frequency region (baseband). The downconverted signal is fed to Analog to Digital converter (ADC), to digitize the signal and this digitized signal is fed to the a baseband processing unit. The baseband processing units is based on an FPGA. The FPGA processes the input based on the software modules which are active at that point of time. These software modules are embedded into the FPGA and they match the processing performed at the transmitter.

In conventional SDR system which generate modulation such as PSK, QAM, the baseband signal has two separate components, the I and Q. The I and O are fed directly to the RF section to generate the composite signal at the RF which consists of the two sideband of which one sideband is filtered. This requires precision filtering at the radio frequency section.

Advantageously, in the present invention, the need of the filter at the RF section has been avoided by using an innovative approach to the RF up conversion. The baseband signal I and Q are added in the baseband itself and comes out as only one output. This output is fed to a phase shifter to generate a 90 degree phase shifted version of the signal. When the baseband signal and the 90 degree phase shifted version are fed to the RF section, the RF output consists of only one sideband and thus eliminates the need of filtering at the RF output.

FIG. 2 shows the subsystems residing within the transmitting unit. These subsystems are embedded as software modules and can be selected in two different ways. One way of selection is to select these modules manually and to set it to a predefined mode of operation. For this operation a set of manual controls are provided externally. The other way is to perform this selection adaptively to match the environment and the requirements of the communication link. In this embodiment of the invention, the transmitter and receiver determine the type of the communication technique adaptively to suit the channel of the transmission link. This adaptive selection is performed by a master control software module which controls all the operations of the system including the RF section.

In the present embodiment of the invention, a multitude of techniques are included in the modulation subsystem. These include the following techniques
1. Amplitude shift keying (AFK),
2. Frequency Shift Keying (FSK),
3. Binary Phase shift keying (BPSK)
4. Quaternary Phase shift Keying (QPSK),
5. 8-PSK
6. Quadrature Amplitude Modulation (QAM)
7. 8-QAM
8. 16-QAM
9. Orthogonal frequency Division Multiplexing (OFDM)

These communication techniques are selectable by the user manually or the master control software.

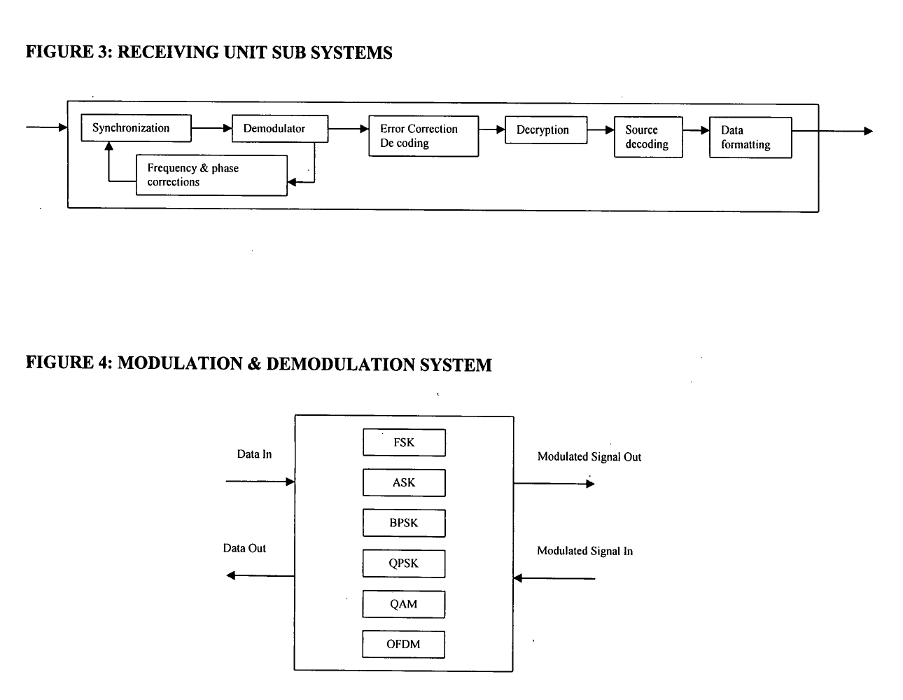

FIG. 3 illustrates the various subsystems which reside inside the receiver unit. These subsystems are mainly the synchronization, demodulation, frequency and phase offset correction, error correction decoding, decryption and finally data formatting. These subsystems has various options present as software modules and each module is selected to match the operation performed at the transmitter. For instance, if the modulation selected is QPSK at the transmitter, the demodulation should also be QPSK demodulation and the algorithms at the synchronization also has a QPSK costas loop. As is the case of transmitter, the receiver also consists of the multitude of software modules to perform the reverse operations of the techniques such as ASK, FSK, BPSK, QPSK, QAM, 16-QAM, and OFDM. The transmitter and receiver modulation subsystems are shown in FIG. 4.

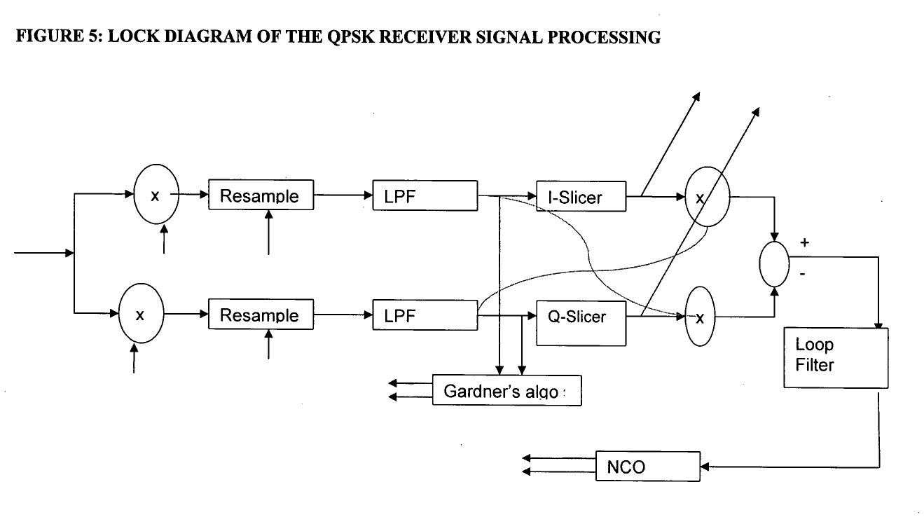

In order to illustrate the receiver signal processing specific to QPSK, the FIG. 5 shows the receiver signal processing in a QPSK receiving system. It consists of various subsystems which are implemented as software modules. The received signal needs to be synchronized and this function is performed by a Digital Costas loop. The digital Costas loop derives an error signal from the received signal based on the channel properties and other imperfections and this error signal is used to drive the numerically controlled oscillator to make its output frequency to be same as the incoming signal frequency.

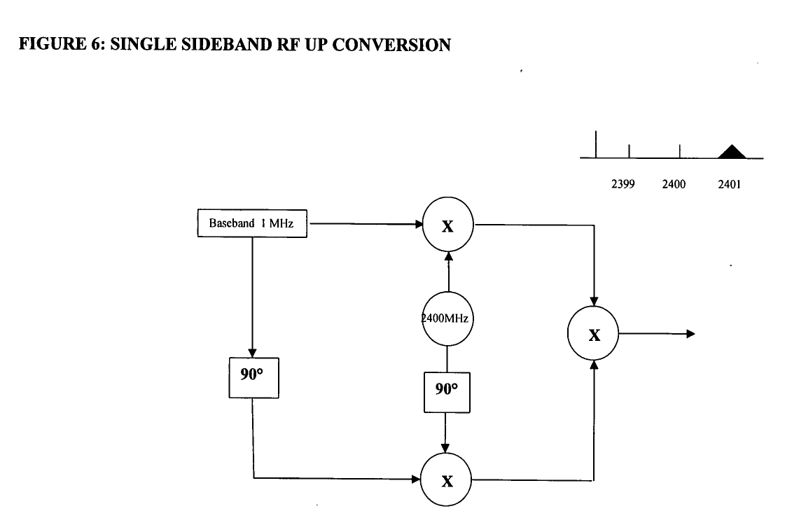

The novel way of the RF up-conversion is further shown in FIG. 6. Here the baseband signal which is one of the many modulated signals is fed to the RF upconverter. The other input to the RF up-converter is the 90 degree phase shifted version of the baseband signal. When these signals are given to the multipliers whose signals are in quadrature, the summed up signal attenuates one of the sideband as shown in the picture. Such as up-conversion eliminates the need of a sideband rejection filter at the RF section.

As clearly apparent from the above illustrations the invention presented consists basically of two distinct sections, the transmitting unit and the receiving unit.

The transmitting system comprises of a Field Programmable Gate Array (FPGA), an analog to digital converter, a digital to analog converter, a Radio Frequency up-conversion circuit, and an antenna, all of which together performs the operation of a wireless communication transmitter whose operational characteristics are determined by the embedded software selected from a multitude of options which are residing in side the FPGA.

The transmitting unit of the system performs the essential operations of a broadband wireless and includes the various subsystems such as a source encoding sub system, data encryption sub system, data interleaving sub system, error correction coding sub system, data formatting sub system, and a multiplicity of digital modulation sub systems and other operations are provided in the form of software modules which are controlled by the master control software module. It offers offering multiple ways of transmitting digital data into the air interface by using the combination of the hardware comprising of an FPGA, analog module, the Radio frequency up-conversion circuit and the antenna;

The digital modulation subsystem of the transmitting unit provides the software modules for a variety of modulation techniques such as frequency shift keying, amplitude shift keying, binary phase shift keying, quaternary phase shift keying, 8 Phase shift keying, 8 quadrature amplitude modulation, 16 quadrature amplitude modulation and orthogonal frequency division multiplexing. These modulation techniques can be selected by the user or as adaptively by a master control software module depending on the performance requirement of the system.

The invention also presents a receiving system which comprises of a Radio frequency down conversion circuit, an analog to digital conversion circuit, a Field Programmable Gate Array (FPGA), a multitude of software modules which reside within the FPGA, all of which together perform the operation of a wireless communication receiving system whose operational characteristics are defined by the embedded software selected from a multitude of options to match the techniques adopted at the transmitter;

The receiving unit of the invention provides the essential receiver signal processing functions which comprises of down converting the received signal to low frequency region for processing in an FPGA, converting the analog signal to a digital signal, and the various subsystems of the receiver such as demodulation subsystem, synchronization subsystem, decryption sub subsystem, error correction decoding subsystem, source decoding sub system and an interface to the user are provided in the form of embedded software modules. It thus offering multiple ways of receiving the radio signal transmitted by the transmitter as required by a SDR based system.

The demodulation subsystem of the receiving unit comprises of the appropriate receive algorithms as embedded software modules residing inside the FPGA for recovering data from the modulation techniques such as frequency shift keying, amplitude shift keying, binary phase shift keying, quaternary phase shift keying, 8 phase shift keying, 8 quadrature amplitude modulation, 16 quadrature amplitude modulation, and orthogonal frequency division multiplexing. Additionally appropriate algorithms are provided for the timing synchronization, carrier frequency and phase offset correction, and other essential signal processing to enhance the received signal integrity and to reduce the number of the errors in the decoded data such as automatic gain control, noise limiting filters and the related techniques as expected in a high performance wireless communication system;

The invention also presents a novel way of integrating the baseband and RF parts of the system whereby the transmitted power, transmission channels and other parameters of the system can be controlled by the master control software. This novel integration method integrates separate hardware modules such as Field programmable gate array, Analog module and the Radio frequency circuits seamlessly and the functionality and operational characteristics are controlled by a master control software module residing within the FPGA;

The above disclosed wireless communication system involving the SDR methodology of communication system is thus adapted to provide control of a variety of modulation techniques, wide-band or narrow-band operation, communications security functions (such as hopping), and waveform requirements of current and evolving standards over a broad frequency range. The system involving the SDR architectures allow wireless devices to break free from predefined functions and capabilities, allowing new features to be implemented in real time including the ability to update and change modulation schemes, protocol standards, and frequency bands. Importantly, the system of the invention, the Software defined radio based wireless communication platform, is an end to end design platform which provides a flexible and reconfigurable design platform for design and rapid prototyping of a broadband wireless communication system based on SDR methodology.

1. A wireless communication system platform adapted for Software Defined Radio (SDR) methodology comprising:
a) transmitting system comprising of a Field Programmable Gate Array (FPGA) with embedded software, an analog to digital converter, a digital to analog converter, a radio frequency up-conversion circuit and antenna, all operatively connected to constitute a wireless communication transmitter adapted for operational characteristics based on the software embedded FPGA;
b) receiving system comprising of a radio frequency down conversion circuit, an analog to digital conversion circuit, a Field Programmable Gate Array (FPGA) with embedded software, all operatively connected to constitute a wireless communication receiving system with selective operational characteristics from a multitude options to match the techniques adapted at the transmitter based on the software embedded FPGA;
said transmitting system and said receiving system adapted for programmability at the baseband and RF sections and providing for said development platform adapted to selectively combine the Field Programmable Gate Array, the analog module comprising of an analog digital converter, digital to analog converter and the radio frequency circuit adapted to perform frequency up conversion or down conversion and amplify the signal strength for complete wireless communication system re-configurable and adaptive for a software defined radio.

2-16. (canceled)

17. A wireless communication system platform according to claim 1 wherein the said transmitting system is adapted to perform the essential operation of a broadband wireless transmitting system wherein various subsystem preferably selected from source encoding subsystem, data encryption sub-system, data interleaving sub system, error correction coding sub system, data formatting sub system, and a multiplicity of digital modulation subsystems and other operations provided in the form of software modules which are controlled by the master control software module thus offering multiple ways of transmitting digital data into the air interface by using the combination of the hardware comprising of said FPGA, analog module, the radio frequency up-conversion circuit and the antenna.

18. A wireless communication system platform according to claim 17 wherein the digital modulation sub-system comprises a multiplicity of modulation techniques preferably selected from frequency shift keying, amplitude shift keying, binary phase shift keying, quaternary phase shift keying, 8 phase shift keying, 8 quadrature amplitude modulation, 16 quadrature amplitude modulation and orthogonal frequency division multiplexing provided as embedded modules which are selected adaptively by either the user or a master controller software module to match the transmitting and receiving environments.

19. A wireless communication system according to claim 1 wherein said receiving system is adapted to perform the essential receiver signal processing functions which comprises of downconverting the received signal to low frequency region for processing in an FPGA, converting the analog signal to a digital signal and the various sub-system of the receiver such as de-modulation subsystem, synchronization subsystem, decryption subsystem, error correction decoding subsystem, source decoding subsystem and an interface to the user provided in the form of embedded software modules thereby providing multiple ways of receiving the radio signal transmitted by the transmitter.

20. A Wireless communication system according to claim 19 wherein the de-modulation subsystem comprises said FPGA having embedded software modules adapted for recovering data from the modulation technique such as frequency shift keying, amplitude shift keying, binary phase shift keying, quaternary phase shift keying, 8 phase shift keying, 8 quadrature amplitude modulation, 16 quadrature amplitude modulation, orthogonal frequency division multiplexing and also provide for the timing synchronization, carrier frequency and phase offset correction and other essential signal processing to enhance the received signal integrity and to reduce the number of the errors in the decoded data such as automatic gain control, noise limiting filter and the related technique as expected in a high performance wireless communication system.

21. A wireless communication system according to claim 20 wherein the said separate hardware modules including Field Programmable Gate Array, analog module and the radio frequency circuit are seamlessly connected and the functionality and operational characteristics are controlled by a master control software module in said FPGA.

22. A wireless communication system according to claim 21 comprising a master control software module adapted to control the operations of the FPGA based processor, the analog module and the radio frequency board from a single interface and enable the selection of the radio frequency channels, radio frequency transmitted power thereby providing a re-configurable radio frequency circuit which is controllable by the user.

23. A wireless communication system according to claim 22 adapted to upconvert the baseband signal to radio frequency signal by generating the sum of in-phase (I) and quadrature (Q) component within the based band and the sum signal thus generated and its 90° phase shifted version adapted to be fed to the RF section whereby one of the side bands of the output is highly attenuated.

24. A wireless communication system according to claim 23 wherein the up-converted signal is fed to an appropriate antenna to match the transmitting frequency.

25. A wireless communication system according to claim 17 wherein the subsystem in the transmitting unit are embedded as software module and adapted to be selectively operated either manually to predetermined mode of operation or adapted to selectively match the environment and requirements of communication link.

26. A wireless communication system according to claim 25 wherein for manual control a set of manual controlled are provided externally.

27. A wireless communication system according to claim 25 wherein for said selective adaptability to match the environment and the requirement of communication link is completed by the master controlled software module and the said transmitter and receiver are adapted to determine the type of communication technique to set the channel of the transmission link.

28. A wireless communication system according to claim 27 wherein the subsystems present as software modules in the receiver is adapted to match the operative performance in the transmitter.

29. A wireless communication system according to claim 28 wherein the received signal is synchronized by a digital Costas loop.
